(19) United States
(12) Patent Application Publication
(10) Pub. No.: US 2025/0024950 A1
(43) Pub. Date: Jan. 23, 2025

(54) HEIGHT ADJUSTMENT MECHANISM FOR A MOVABLE SUPPORT PART OF SEATING FURNITURE AND SEATING FURNITURE

(71) Applicant: HETTICH FRANKE GMBH & CO. KG, Balingen-Weilstetten (DE)

(72) Inventors: Steffen GRATHWOL, Balingen (DE); Oliver NILL, Hechingen (DE)

(21) Appl. No.: 18/715,275

(22) PCT Filed: Nov. 29, 2022
(86) PCT No.: PCT/EP2022/083577

§ 371 Date: May 31, 2024

(30) Foreign Application Priority Data
Dec. 1, 2021 (DE) 10 2021 131 631.6

(51) Int. Cl. A47C 7/38; B60N 2/829

(52) U.S. Cl. CPC A47C 7/38; B60N 2/829

(57) ABSTRACT

A height adjustment mechanism for a movable support part of a piece of seating furniture has a guide rod fastenable to a back part of the piece of seating furniture, a bracket support guided on the guide rod so as to be displaceable in the longitudinal direction of the guide rod, at least one support part bracket fastened to the bracket support, a drive unit fastened to the back part of the seating furniture, and an electric motor and a drive shaft drivable by the electric motor and by which the bracket support is displaceable by a motor along the guide rod, a traction drive coupled to the bracket support and driven by the drive shaft being fastened to the guide rod.

### BACKGROUND AND SUMMARY OF THE INVENTION

Exemplary embodiments of the present invention relate to a height adjustment mechanism for a movable support part of a piece of seating furniture and to a piece of seating furniture.

Generic height adjustment mechanisms for headrests are described, for example, in DE10130694B4, DE102018101721A1, or DE202018106444U1 is known. The height adjustment mechanisms for a headrest described in these publications have respective support part brackets that are fixed to respective bracket supports. The bracket supports are height-adjustable by means of threaded rods or motor-driven gear racks and gear wheels.

The disadvantage of the height adjustment mechanisms described in these publications is their complex and cost-intensive design.

Exemplary embodiments of the present invention are directed to a height adjustment mechanism for a movable support part of a piece of seating furniture, which is simple in design and can be manufactured at low cost.

The height adjustment mechanism according to the invention for a movable support part of a piece of seating furniture has a guide rod attached to a back part of the piece of seating furniture and a bracket support guided on the guide rod so as to be displaceable in the longitudinal direction of the guide rod. At least one support bracket is attached to the bracket support.

Furthermore, a drive unit with an electric motor and a drive shaft that can be driven by the motor is attached to the back part of the seating furniture, with which the bracket support can be moved along the guide rod by a motor.

A flexible traction drive coupled to the bracket support and driven by the drive shaft is attached to the guide rod.

Such a traction drive provides a simple and inexpensive height adjustment mechanism with which the headrest on a piece of seating furniture can be adjusted in height easily.

According to an advantageous design variant, the traction means is designed as a cable drive.

Alternatively, a belt drive or a chain drive is also conceivable as a means of traction.

Such a cable drive is a particularly simple, relatively maintenance-free design variant of such a traction drive.

According to a preferred embodiment, fixing elements spaced apart from one another are arranged on the bracket support for releasably fixing free ends of bracket rods of the support part bracket.

In a preferred further development, each of the fixing elements has a spring housing with a spring element fixed therein and an insertion funnel, through which the respective free end, formed with a radial groove, of one of the shackle rods of the support part shackle can be inserted into the spring housing and latched with the spring element with a predetermined spring force.

In addition to the simple fixing of the support bracket using fixing elements designed in this way, these fixing elements also ensure reliable pinch protection.

This pinch protection means that when the headrest approaches the upper edge of the backrest, a part of a person's body located between these components can only be compressed with a low force that does not pose a risk of injury, as the spring elements of the fixing elements release the bars of the support bar when a predetermined pressure force is exceeded, thereby reliably preventing the body part from being crushed.

According to another preferred design variant, the bracket rods are guided in sliding guide sleeves, which are inserted into receptacles in the back part.

This means that the support bracket can be reliably guided parallel to the longitudinal axis of the guide rod.

According to a further preferred embodiment, a first driver is arranged on a traction means of the traction means drive, which is fixed in a driver mount of the bracket support.

The driver can be designed in the form of a cylinder bolt, for example.

According to a preferred further development, cable ends of a traction means designed as a cable of the traction means drive designed as a cable drive have second drivers which are fixed to a cable wheel of the cable drive.

This makes it possible to transmit greater drive forces via the cable, as the second driver prevents the cable from slipping in the cable wheels.

According to a further preferred embodiment of the height adjustment mechanism according to the invention, at least one limit switch electrically coupled to the electric motor is arranged on the guide rod, which serves to limit a travel path of the bracket support along the guide rod. Two limit switches are also advantageous in order to limit the movement of the bracket support in both end positions.

According to a preferred further development, a circuit board is attached to the guide rod, on which at least one of the limit switches can be arranged in variable positions.

This allows the end user to adjust the maximum height adjustment range for the headrest as well as the minimum and maximum adjustment heights.

The seating furniture according to the invention has a seat and a backrest arranged at an angle to the seat with a back part accommodated therein and a headrest. Furthermore, the seating furniture has a height adjustment mechanism, as described above, for adjusting the height of the headrest relative to the back part.

It is also conceivable to use a height adjustment mechanism according to the invention in a seat of a motor vehicle.

### BRIEF DESCRIPTION OF THE DRAWING FIGURES

In the following, preferred embodiments of the invention are explained in more detail with reference to the accompanying drawings, wherein:

FIG. 1 shows an isometric representation of an embodiment of a height adjustment mechanism according to the invention with a headrest arranged in a height-adjustable manner on a back part,

FIG. 2 shows an illustration of the height adjustment mechanism from a different perspective, corresponding to FIG. 1,

FIG. 3 shows a further isometric representation of the headrest arranged on the back part in a lowered position of the headrest,

FIG. 4 shows an isometric exploded view of the structure consisting of the back part, headrest and height adjustment mechanism,

FIG. 5 shows an isometric view of the height adjustment mechanism,

FIG. 6 shows an exploded view of the height adjustment mechanism shown in FIG. 5,

FIG. 7 shows an isometric view of a bracket support slidably attached to a guide rod in the lowered state,

FIGS. 8a to 8c show different representations of the bracket support in the lowered state on a cable drive,

FIGS. 9a to 9c show representations of the bracket support on a cable drive corresponding to FIGS. 8a to 8c when the bracket support is raised,

FIG. 10: shows a top view of a bracket support attached to the guide rod in the lowered state with limit switches and circuit board arranged on the guide rod,

FIG. 11: shows an illustration corresponding to FIG. 10 with the bracket support in the raised position, triggering the upper limit switch,

FIG. 12 shows an isometric enlargement of the height adjustment mechanism to show how the bracket rods of the support bracket are fixed to the fixing elements of the bracket support,

FIG. 13 shows a top view of a detail of FIG. 12 with a cut fixing element showing a bow rod locked by a spring element,

FIGS. 14 and 15 show schematic isometric representations of a piece of seating furniture with backrest and adjustable headrest arranged thereon in the lowered (FIG. 14) or raised (FIG. 15) position and

FIGS. 16 and 17 show schematic isometric representations of an alternative embodiment of a piece of seating furniture with an adjustable backrest in the lowered (FIG. 16) or raised (FIG. 17) position.

### DETAILED DESCRIPTION

In the following description of the figures, terms such as top, bottom, left, right, front, rear, etc. refer exclusively to the exemplary representation and position of the headrest, backrest section, guide rod, support section bracket, drive unit and the like selected in the respective figures. These terms are not to be understood restrictively, i.e. these references may change due to different working positions or mirror-symmetrical design or the like.

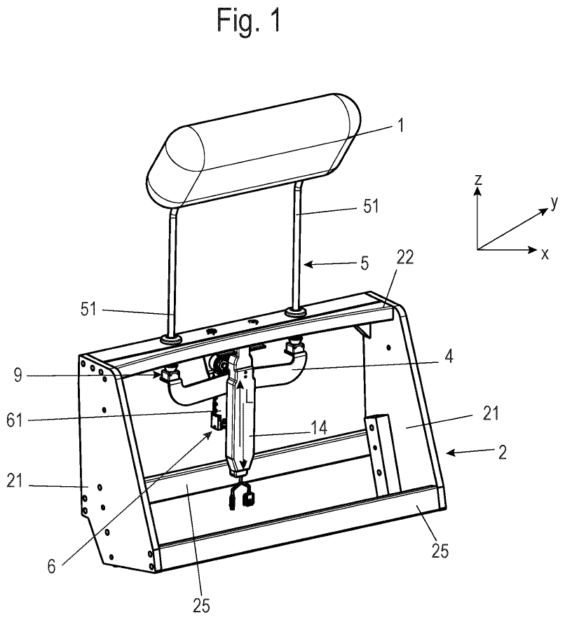

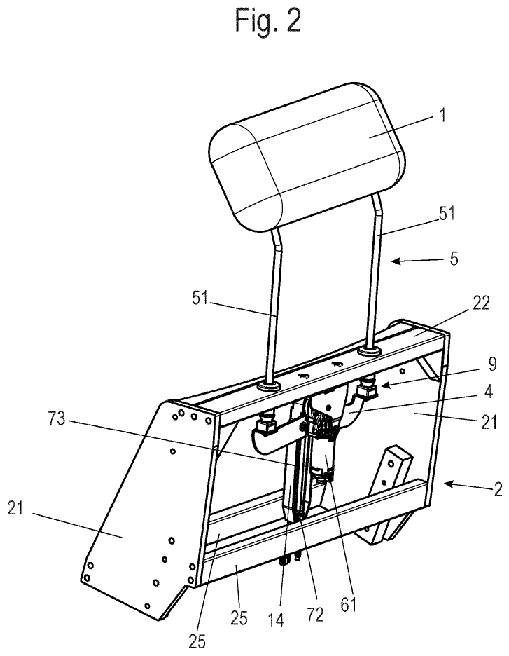

In FIGS. 1 and 2, the reference sign 1 indicates a movable support part of a piece of seating furniture 100 in the form of a headrest, which is attached to a back part 2 of the piece of seating furniture 100 by means of a drive unit 6 of a height adjustment mechanism so that it can be adjusted in height by an electric motor.

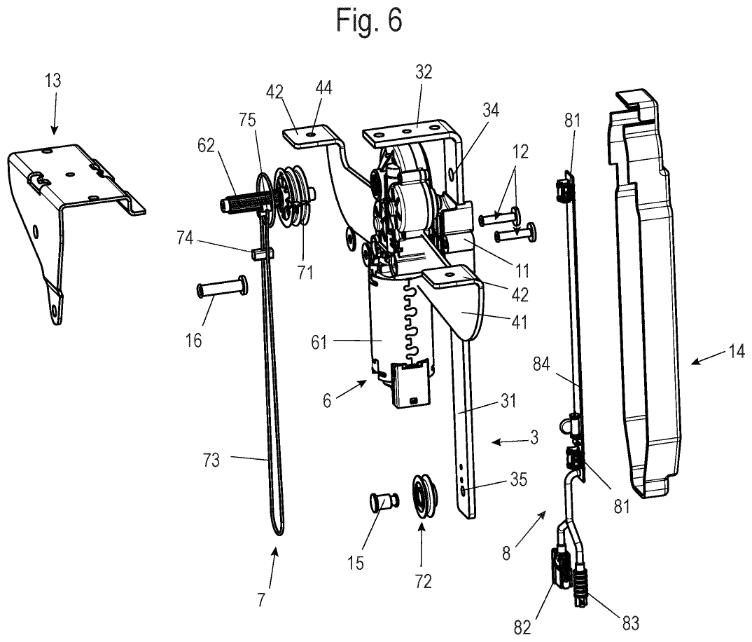

The height adjustment mechanism, which is shown as an exploded view in FIG. 6, has a guide rod 3 that can be attached to a back part 2 of the seating furniture 100. The guide rod 3 has a guide section 31 on which a bracket support 4 is displaceably guided. The bracket support 4 is guided on the guide rod 3 so that it can be moved in the longitudinal direction L of the guide rod 3.

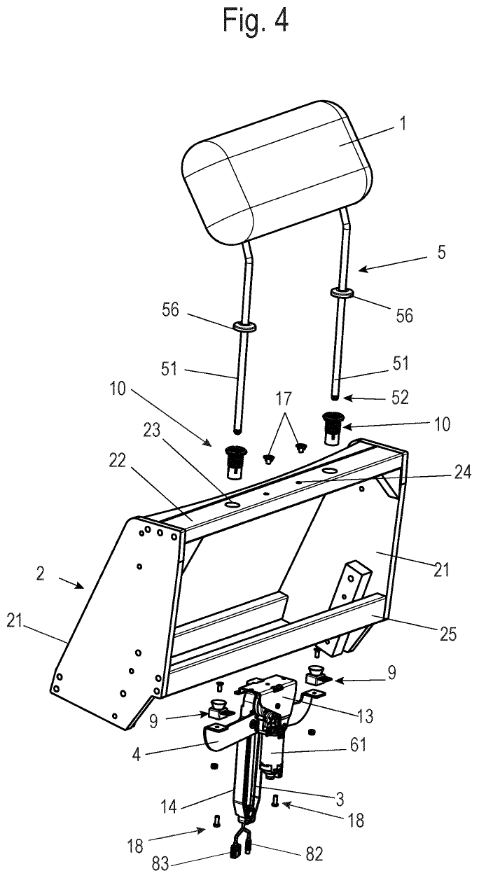

A support bracket 5 is attached to the bracket support 4, as shown in FIGS. 1 to 4. The support bracket 5 essentially has two bracket rods 51 running parallel to each other, the cross connection of which is designed as a preferably padded headrest 1. Free ends 52 of the bracket rods 51 are fixed to the bracket support 4 via fixing elements 9, as will be explained in more detail below.

In principle, a design variant of a support bracket 5 with only one bracket rod 51 fixed to the bracket support 4 via a fixing element 9 is also conceivable.

A drive unit 6 of the height adjustment mechanism is also attached to the back part 2 of the seat.

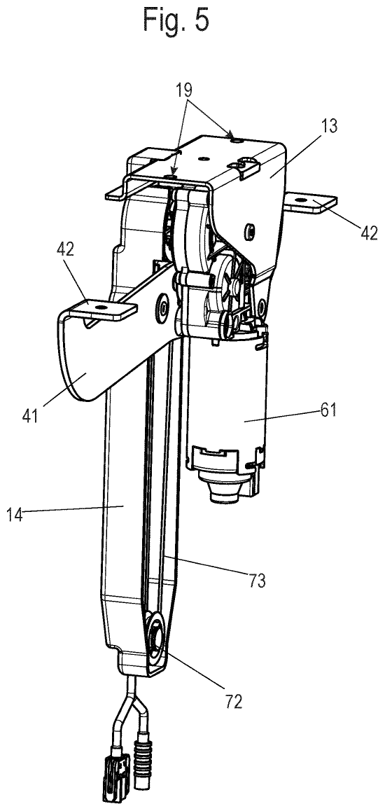

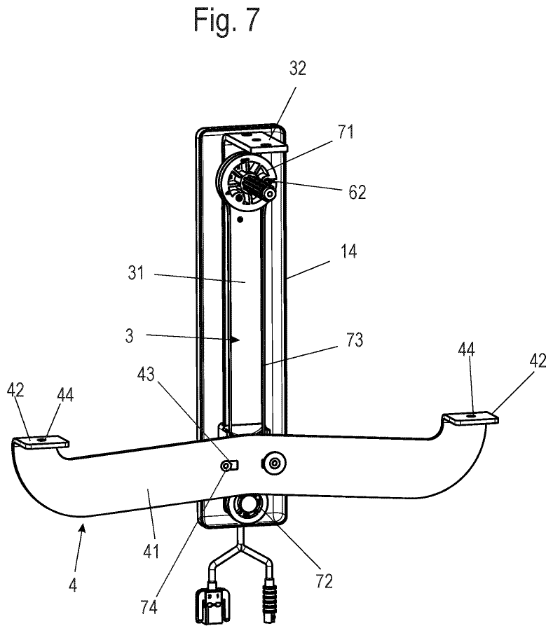

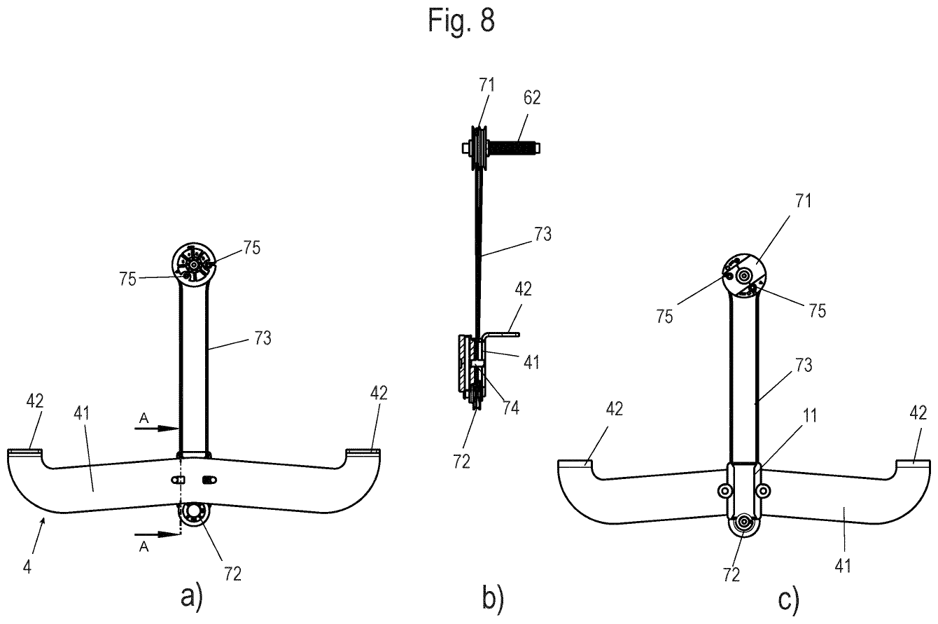

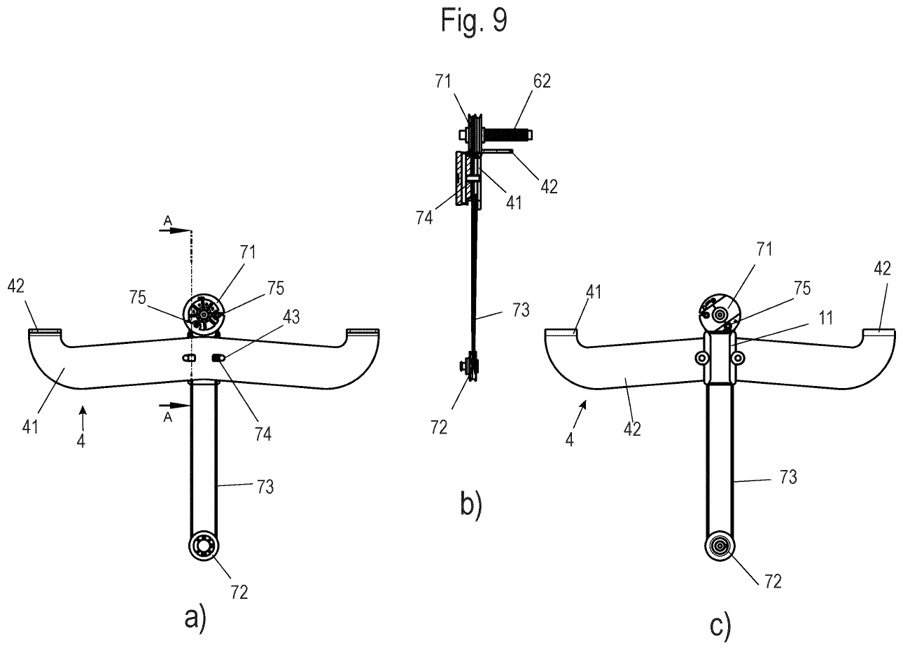

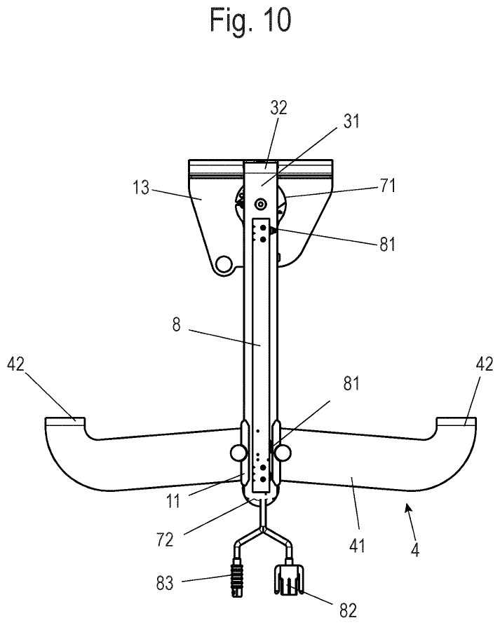

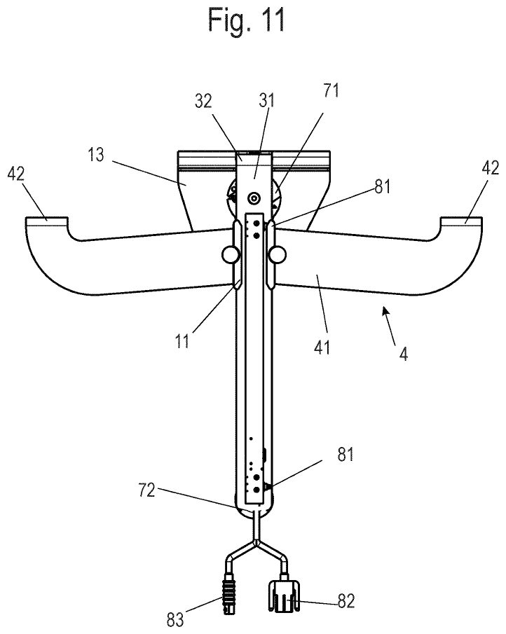

The drive unit 6 has an electric motor 61 and a drive shaft 62 that can be driven by it. In order to move the bracket support 4 along the guide rod 3, a traction drive coupled to the bracket support 4 and driven by the drive shaft 62 is attached to the guide rod 3, as can be seen in FIGS. 2 to 12.

In the embodiment shown in the figures, the traction drive is designed as a cable drive 7.

The cable drive 7 essentially consists of two cable wheels 71, 72. A first cable wheel 71 is coupled to the drive shaft 62 of the drive unit 6 in order to rotate the cable wheel 71 about its axis of rotation.

The two cable wheels 71, 72 are connected to each other by a cable 73. In order to prevent the cable 73 from slipping in the locating grooves of the cable wheels 71, 72, in which the cable 73 is located, second drivers 75 are preferably arranged at the cable ends of the cable 73, which are fixed in the locating grooves of the first cable wheel 71 of the cable drive 7 provided for this purpose.

Furthermore, a first driver 74 is attached to the cable 73, which is fixed in a driver mount 43 of the bracket support 4.

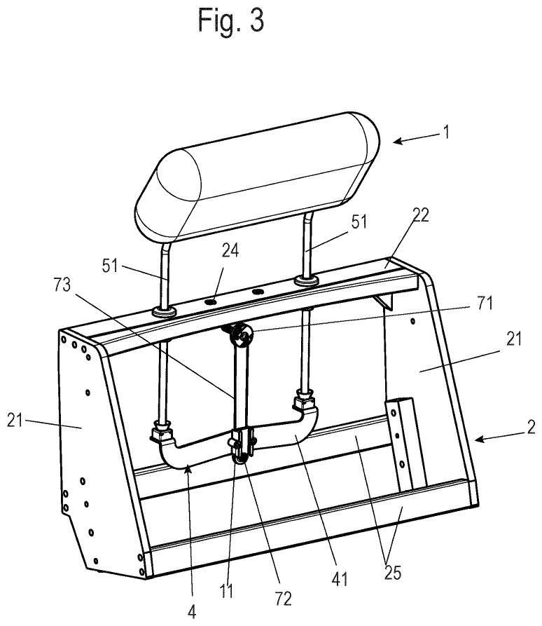

This first driver 74 is used to transmit the movement of the cable 73 to the bracket support 4, which can thus be moved along the guide rod 3 between a lower setting shown in FIGS. 3, 7 and 8a to 8c and an upper end position shown in FIGS. 1, 2 and 9a to 9c, depending on the direction of movement of the cable 73 along the guide section 31 of the guide rod 3.

As shown in FIGS. 6, 10 and 11, two limit switches 81 electrically coupled to the electric motor 61 are arranged on the guide rod 3 for variable adjustment of the lowest and highest position of the headrest 1, which serve to limit the travel of the bracket support 4 along the guide rod 3.

The two limit switches 81 are preferably attached to a circuit board 8, which is fixed to the guide rod 3. The limit switches 81 can preferably be arranged in variable positions on this circuit board 8.

As further shown in FIGS. 6, 10 and 11, two contact elements, designed as plugs 82, 83, are arranged at one end of the circuit board 8, which serve to transmit signals between the limit switch 81 and the motor 61 of the drive unit 6.

The bracket support 4 essentially consists of a cross plate 41, from the ends of which bent support tongues 42 extend, which are essentially aligned in the XY plane.

One of the fixing elements 9 is attached to the top of each of these support tongues 42, which serves to fix the bracket rods 51 of the support bracket 5. For this purpose, the support tongues 42 have holes 44. The fixing elements 9 are held on these holes 44 by screws 18.

In order to provide simple clamping protection on the height adjustment mechanism, the free ends 52 of the bracket rods 51 of the support bracket 5 are detachably arranged in the fixing elements 9.

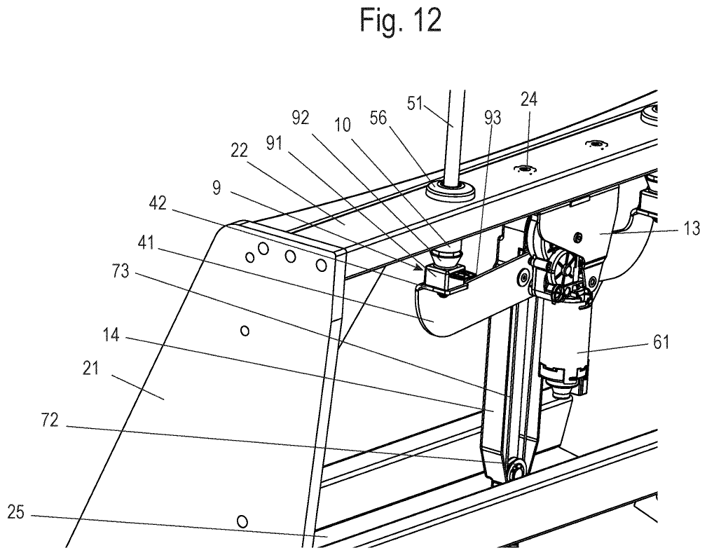

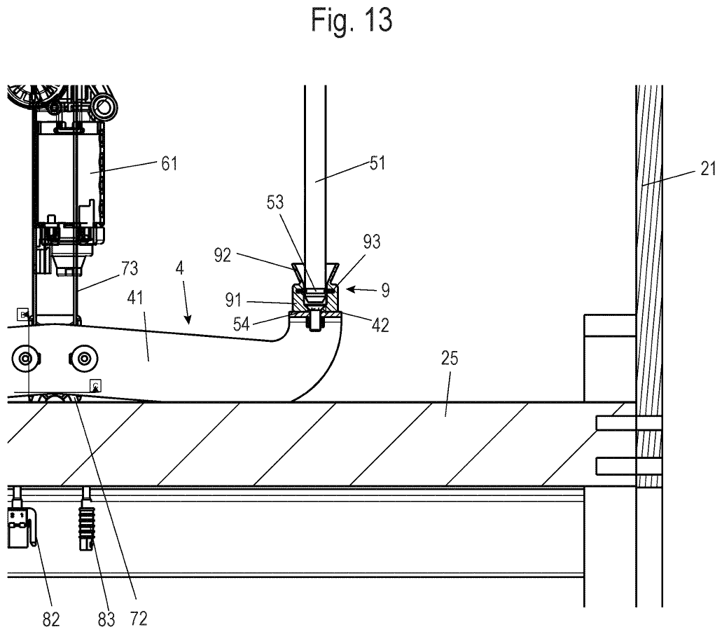

As shown in FIGS. 12 and 13, each of the fixing elements 9 has a spring housing 91 with a spring element 93 held therein, for example in the form of a wire clamping spring, and an insertion funnel 92.

When mounting the support bracket 5, the free end 52 of the respective bracket rod 51 is inserted through the insertion funnel 92 into the spring housing 91. A chamfer 54 facilitates the insertion of the free end 52 of the U-bar 51 into the insertion funnel 92.

The free ends 52 of the bracket rods 51 each have a radial groove 53, into which the spring element 93 engages with a predetermined spring force after the free ends 52 of the bracket rods 51 have been inserted into the spring housing 91, thus locking the bracket rods 51.

If a predetermined force is exceeded, the spring element 93 can slide out of the radial groove 53 at the free end 52 of the bracket rod 51 and thus release the headrest 1 again.

For easy sliding guidance of the bracket rods 51 of the support bracket 5, the bracket rods 51 are guided in sliding guide sleeves 10, which are inserted in receptacles 23 in the back part 2, as shown, for example, in FIGS. 1, 2, 4 and 12.

The respective end of the sliding guide sleeves 10 protruding upwards out of the back part 2 is covered by a cover cap 56 threaded onto the bracket rods 51.

The receptacles 23 in the back part 2 are preferably provided in an upper cross strut 22 of the back part 2.

The back part 2 itself essentially consists of two side walls 21, the upper cross strut 22 and one or more lower cross strut(s) 25.

In addition, a mounting bracket 13 is preferably attached to the upper cross strut 22, which serves to hold the drive unit 6 and the guide rod 3. The mounting bracket 13 is fastened through holes 24 using screws 17. For this purpose, the mounting bracket 13 has bores 19.

For this purpose, the guide rod 3 has a fastening section 32 that is bent at an angle to the guide section 31 and is fastened, in particular screwed or riveted, to the mounting bracket 13.

Furthermore, bearing bores 34, 35 are provided in the area of the fastening section 32 of the guide rod 3, which are used for the pivot bearing of the two cable wheels 71, 72. For this purpose, the upper cable wheel 71 is attached to the bearing bore 34 by means of a rivet 16 and the lower cable wheel 72 is attached to the bearing bore 35 by means of a rivet 15, as shown in FIG. 6.

The guide rod 3 and the components attached to it are also preferably covered by a cover frame 14.

The movable guide of the bracket support 4 on the guide rod 3 can be provided by a clamp or a sledge formed on the cross plate 41 of the bracket support 4.

In the embodiment shown here, the bracket support 4 is coupled to the guide rod 3 via a sledge 11, which grips around the guide section 31 of the guide rod 3 from at least three sides when viewed in the horizontal plane and is connected to the bracket support 4 via screws or rivets 12.

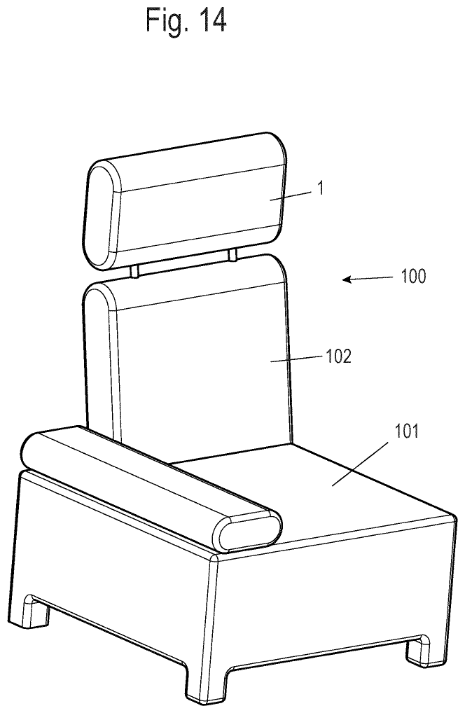

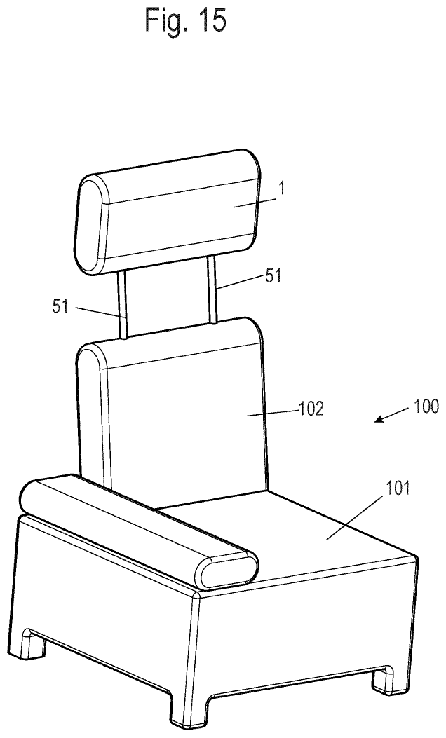

FIGS. 14 and 15 show a piece of seating furniture 100 with a seat surface 101, a backrest 102 arranged at an angle to it, in which the back part 2 is accommodated and to which the support bracket 5 is attached for holding the support element arranged above the back part 2, here in the form of a headrest 1.

The height position of the support bracket 5 together with the headrest 1 relative to the upper edge of the backrest 2 can be adjusted by a motor using a height adjustment mechanism as described above. FIG. 14 shows a lowered position of the headrest 1, while FIG. 15 shows a raised position of the headrest 1.

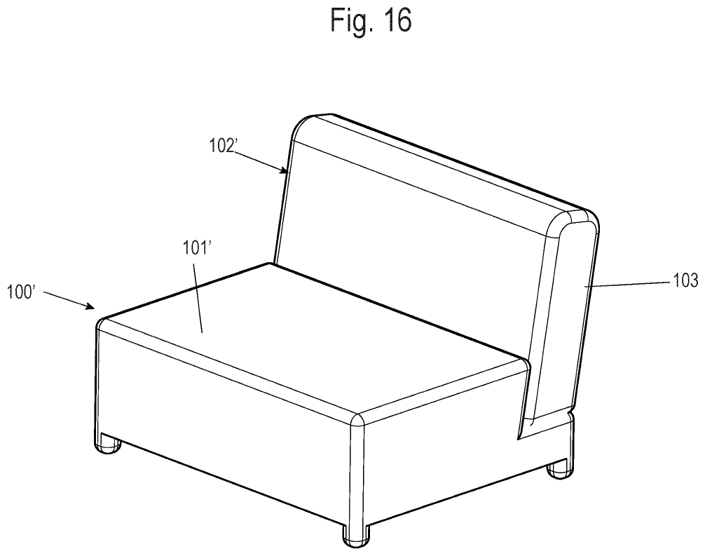

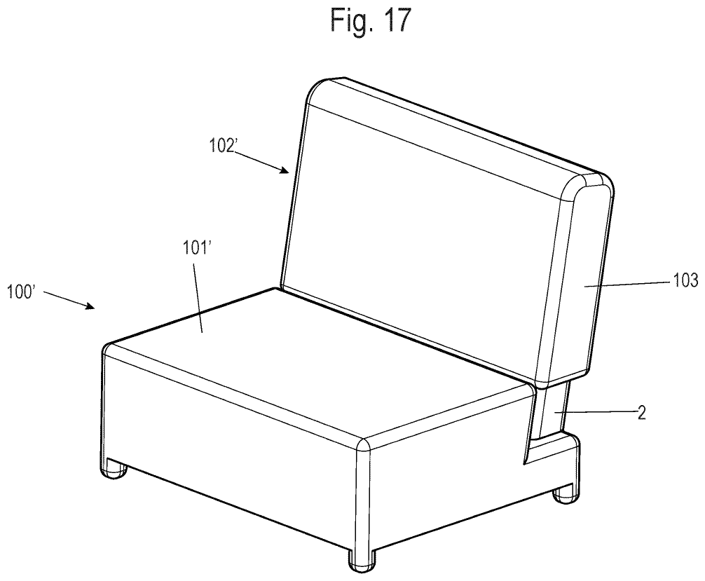

FIGS. 16 and 17 show a second piece of furniture 100′ with a seat 101′ and a backrest 102′. The backrest 102′ here consists of the back part 2 and a support part in the form of an upholstered part 103′ which is placed over it. The upholstered part 103′ can be adjusted relative to the back part 2 using the height adjustment mechanism. FIG. 16 shows a lowered position of the upholstered part 103′, while FIG. 17 shows a raised position of the upholstered part 103′.

The height adjustment mechanisms and seating furniture according to the invention can also be used in motor vehicles.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SYMBOLS

1 Headrest
2 Back part
21 Side wall
22 Upper cross strut
23 Receptacle
24 Hole
25 Lower cross strut
3 Guide rod
31 Guide section
32 Fastening section
34, 35 Bearing bore
4 Bracket support
41 Cross plate
42 Support tongue
43 Driver mount
44 Hole
5 Support bracket
51 Bracket bar
52 Free end
53 Radial groove
54 Chamfer
6 Drive unit
61 Motor
62 Drive shaft
7 Cable drive
71 Cable wheel
72 Cable wheel
73 Cable
74 first driver
75 Second driver
8 Circuit board
81 Limit switch
82 Plug
83 Plug
9 Fixing element
91 Spring housing
92 Insertion funnel
93 Spring element
10 Sliding guide sleeve
11 Sledges
12 Rivet
13 Mounting bracket
14 Cover frame
15 Rivet
16 Rivet
17 Screw
18 Screw
19 Bore
100 Seating furniture
101 Seat
102 Backrest
100′ Seating furniture
101′ Seat
102′ Backrest
103′ Upholstered part
L Longitudinal direction
X Direction
y Direction
Z Direction

1-11. (canceled)

12. A height adjustment mechanism for a movable support part of a seating furniture, the height adjustment mechanism comprising:
a guide rod configured to be attached to a back part of the seating furniture;
a bracket support displaceably guided on the guide rod in the longitudinal direction of the guide rod;
at least one support bracket attached to the bracket support;
a drive unit, attached to the back part of the seating furniture, having an electric motor, a drive shaft drivable by the electric motor and with which the bracket support is displaceable along the guide rod by the electric motor; and
a flexible traction drive, coupled to the bracket support and driven by the drive shaft, attached to the guide rod.

13. The height adjustment mechanism of claim 12, wherein the flexible traction drive is a cable drive, belt drive, or chain drive.

14. The height adjustment mechanism of claim 12, further comprising:
fixing elements, which are spaced apart from one another and are arranged on the bracket support for releasably fixing free ends of bracket rods of the at least one support part bracket.

15. The height adjustment mechanism of claim 14, wherein each of the fixing elements has a spring housing with a spring element fixed in the spring housing and an insertion funnel through which the respective free end, formed with a radial groove, of one of the bracket rods of the support part bracket is insertable into the spring housing and is latchable with the spring element with a predetermined spring force.

16. The height adjustment mechanism of claim 15, wherein each of the spring elements is configured in such a way that when the predetermined spring force is exceeded, the respective bracket rod of the support part bracket is releasable from the latching with the spring element.

17. The height adjustment mechanism of claim 14, wherein the bracket rods of the support part bracket are guided in sliding guide sleeves that are inserted in receptacles in the back part.

18. The height adjustment mechanism of claim 12, further comprising:
a first driver arranged on a traction means of the traction means drive, which is fixed in a driver mount of the bracket support.

19. The height adjustment mechanism of claim 18, wherein the traction means drive is a cable drive having a cable with cable ends having second drivers fixed to a cable wheel of the cable drive.

20. The height adjustment mechanism of claim 12, further comprising:
two limit switches electrically coupled to the electric motor arranged on the guide rod to limit a travel path of the bracket support along the guide rod.

21. The height adjustment mechanism of claim 20, further comprising:
a plate attached to the guide rod and on which the limit switches are arranged in variable positions.

22. A seating furniture, comprising:
a seat;
a backrest arranged at an angle to the seat, having a back part accommodated in the backrest, and having a support part movable relative to the back part; and
a height adjustment mechanism for height adjustment of the movable support part relative to the back part, wherein the height adjustment mechanism comprises
a guide rod configured to be attached to a back part of the seating furniture;
a bracket support displaceably guided on the guide rod in the longitudinal direction of the guide rod;
at least one support bracket attached to the bracket support;
a drive unit, attached to the back part of the seating furniture, having an electric motor, a drive shaft drivable by the electric motor and with which the bracket support is displaceable along the guide rod by the electric motor; and
a flexible traction drive, coupled to the bracket support and driven by the drive shaft, attached to the guide rod.

23. The seating furniture of claim 22, wherein the movable support part is a headrest or an upholstered part arranged on the back part.
